(19) United States
(12) Patent Application Publication
(10) Pub. No.: US 2026/0015235 A1
(43) Pub. Date: Jan. 15, 2026

(54) SALT COMPOSITION FOR AN ELECTROLYTE, HAVING A LOW CONTENT OF SULFAMATE IONS

(71) Applicant: Arkema France, Colombes (FR)

(72) Inventors: Julien JOUANNEAU, PIERRE-BENITE Cedex (FR); Jean-Luc COUTURIER, PIERRE-BENITE Cedex (FR); Jérémy BAUCHE, PIERRE-BENITE Cedex (FR)

(73) Assignee: Arkema France, Colombes (FR)

(21) Appl. No.: 18/996,542

(22) PCT Filed: Jul. 17, 2023
(86) PCT No.: PCT/FR2023/051094

§ 371 Date: Jan. 17, 2025

(30) Foreign Application Priority Data
Jul. 22, 2022 (FR) FR2207557

(51) Int. Cl. C01B 21/093; H01M 4/583; H01M 10/054; H01M 10/0568

(52) U.S. Cl. CPC C01B 21/0935; H01M 4/583; H01M 10/054; H01M 10/0568; C01P 2002/86; C01P 2006/40; C01P 2006/82

(57) ABSTRACT

The invention relates to a composition comprising a salt composed of a sodium cation and an anion of formula (II):

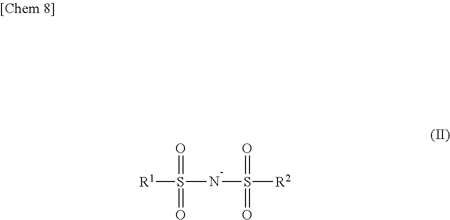

wherein R¹ and R² independently represent a fluorine atom or a perfluorinated group, the composition having a sulfamate ion content of from 0.1 to 3000 ppm by weight. The invention also relates to a process for preparing this composition and to an electrolyte comprising same.

### FIELD OF THE INVENTION

The present invention relates to a salt composition for an electrolyte intended for a sodium-ion battery, and to a process for preparing same, and to an electrochemical cell incorporating an electrolyte containing this composition.

### TECHNICAL BACKGROUND

Lithium-ion (Li-ion) batteries are commonly used in electric vehicles and in mobile and portable devices.

Sodium-ion (Na-ion) batteries are a more environmentally-friendly alternative to Li-ion batteries.

An Na-ion battery comprises at least a negative electrode (anode), a positive electrode (cathode), an electrolyte and preferably a separator. The electrolyte is generally formed from a sodium salt dissolved in a solvent which may be a mixture of organic solvents, so as to achieve a good compromise between the viscosity and the dielectric constant of the electrolyte.

The passivation layers formed during the first charge/discharge cycles of a battery are essential for battery lifespan. Passivation layers include in particular the passivation of aluminum, which is generally the current collector used at the cathode, and the solid-electrolyte interface (SEI), which is the inorganic and polymeric layer that is formed at the anode/electrolyte and cathode/electrolyte interfaces. The stability of these interfaces is a substantial challenge for improving battery lifespan.

Regarding the prior art of Na-ion batteries, reference is made to the following review articles:
Hwang et al., Sodium-ion batteries: present and future, in Chem. Soc. Rev., 46:3529-2614 (2017);
Chen et al., Readiness Level of Sodium-Ion Battery Technology: A Materials Review, in Adv. Sus. Sys., DOI: 10.1002/adsu.201700153 (2018);
Eshetu et al., Electrolytes and Interphases in Sodium-Based Rechargeable Batteries: Recent Advances and Perspectives, in Adv. Energy Mater., 10:2000093 (2020).

In the latter, various electrolytes for Na-ion batteries are presented. NaFSI (sodium bis(fluorosulfonylimide)) is mentioned as a possible electrolyte salt.

Document EP 2578533 describes alkali metal salts (preferably lithium salts) of fluorosulfonylimide type having a sulfate ion content of less than 3000 ppm.

Document U.S. Pat. No. 9,440,852 describes an NaFSI (sodium bis(fluorosulfonylimide)) salt with a purity of greater than or equal to 99.5% by weight, containing no water, and in which each of the NaCl, NaF and NaFSO₃ impurities are present in a content of less than or equal to 1000 ppm.

Document JP 6592380 discloses an electrolyte for an Na-ion battery containing NaFSI and propylene carbonate (PC) with a specific ratio between the PC and the sodium.

Document EP 3985775 teaches an electrolyte comprising a sodium salt, solvents of carbonate type and additives (alkylene carbonate or nitrile). NaFSI is mentioned among the list of possible sodium salts.

Document WO 2019/229359 describes a process for manufacturing salts such as lithium bis(fluorosulfonyl)imide (LiFSI) from bis(fluorosulfonyl)imide (HFSI).

There is a need to provide a composition useful for preparing an electrolyte for Na-ion batteries, having advantageous properties in terms of non-flammability, performance and in particular battery lifespan, and which can be manufactured by a simple and inexpensive process.

### SUMMARY OF THE INVENTION

The invention relates firstly to a composition comprising a salt composed of a sodium cation and an anion of formula (II): [Chem 1]

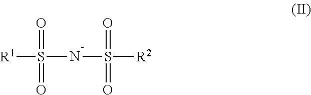

wherein R¹ and R² independently represent a fluorine atom or a perfluorinated group, the composition having a sulfamate ion content of from 0.1 to 3000 ppm by weight.

In certain embodiments, the anion of formula (II) is the bis(fluorosulfonyl)imide anion or the bis(trifluoromethylsulfonyl)imide anion, preferably the bis(fluorosulfonyl)imide anion.

In certain embodiments, the sulfamate ion content is from 1 to 1000 ppm, preferably from 10 to 300 ppm, by weight.

In certain embodiments, the salt is present in a weight content of greater than or equal to 99.5% by weight, preferably greater than or equal to 99.8% by weight, more preferably greater than or equal to 99.9% by weight.

In certain embodiments, the composition also comprises, by weight:
from 0 to 500 ppm of water, preferably from 0.5 to 100 ppm and more preferably from 1 to 50 ppm;
from 0 to 50 ppm of Cl⁻ ions, preferably from 0.5 to 20 ppm, more preferably from 1 to 10 ppm;
from 0 to 100 ppm of F⁻ ions, preferably from 0.5 to 50 ppm, more preferably from 1 to 10 ppm;
from 0 to 3000 ppm of SO₄²⁻ ions, preferably from 0.5 to 500 ppm, more preferably from 1 to 20 ppm;
from 0 to 100 ppm of FSO₃⁻ ions, preferably from 0.5 to 50 ppm, more preferably from 1 to 10 ppm.

The invention also relates to a process for preparing the composition above, comprising:
supplying the compound of formula (I):

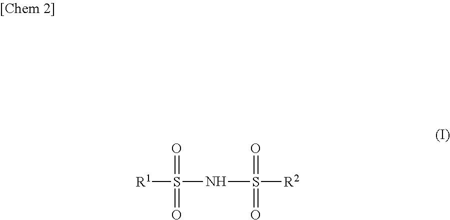

wherein R¹ and R² independently represent a fluorine atom or a perfluorinated group,
reacting the compound of formula (I) with a sodium compound.

In certain embodiments, the compound of formula (I) has a sulfamic acid content of from 1 to 5000 ppm, preferably from 500 to 2500 ppm, by weight.

In certain embodiments, the sodium compound is NaCl, or a sodium base, which is preferably chosen from NaH, NaOH, NaHCO₃, Na₂CO₃ and Na(OAc), and is preferably Na₂CO₃.

In certain embodiments, the reaction is carried out:
in the presence of an organic solvent, preferably chosen from nitriles, esters, ethers, ketones, alcohols, carbonates and combinations thereof; and/or
with a sodium compound/compound of formula (I) mole ratio of from 0.9 to 1.1, preferably from 1 to 1.05; and/or
at a temperature of from −5° C. to 40° C., preferably from 15° C. to 25° C.

In certain embodiments, the process comprises the following step:
synthesizing the compound of formula (I), preferably by fluorination of a chlorinated compound and optionally distillation.

In certain embodiments, the process further comprises the following step:
purifying the reaction mixture after the reaction, preferably by filtration and crystallization.

In certain embodiments, the crystallization is carried out in the presence of a non-solvent for the compound of formula (II), preferably chosen from chlorinated solvents, aromatic solvents, alkanes and combinations thereof.

The invention also relates to an electrolyte comprising the above composition, mixed with one or more solvents and optionally one or more additives.

In certain embodiments, the electrolyte further comprises an ionic liquid, which preferably comprises the FSI or TFSI anion associated with an onium cation.

The invention also relates to an electrochemical cell comprising a negative electrode, a positive electrode and an electrolyte, wherein the electrolyte comprises the above composition.

In certain embodiments, the negative electrode comprises hard and/or soft carbon as the electrochemically active material, and wherein the positive electrode comprises a polyanionic compound comprising sodium.

The invention also relates to a battery comprising at least one electrochemical cell as described above.

The present invention makes it possible to meet the need expressed above.

Advantageously, the composition of the invention makes it possible to improve the quality of the SEI, in an Na-ion battery.

Advantageously, the composition of the invention makes it possible to improve the coulombic efficiency after the formation of the SEI and makes it possible to increase the lifespan of the battery (i.e. to increase the number of cycles for retaining at least 80% of the initial capacity of the battery).

Advantageously, a battery incorporating the composition of the invention exhibits good performance even at high charge and discharge rates.

Advantageously, the composition of the invention can be produced at moderate cost, and in particular without using expensive raw materials such as LiFSI or KFSI.

Advantageously, the purification of this composition is simplified.

Advantageously, use is made of a raw material such as HFSI with a specific quality that makes it possible to easily obtain the composition with high performance levels.

### DETAILED DESCRIPTION

The invention is now described in greater detail and in a nonlimiting manner in the description that follows.

Unless otherwise indicated, all the percentages and proportions are weight percentages and proportions and all the ratios between two quantities are weight ratios.

### Composition Comprising the Salt

The invention relates firstly to a composition comprising at least one salt composed of an anion of formula (II):

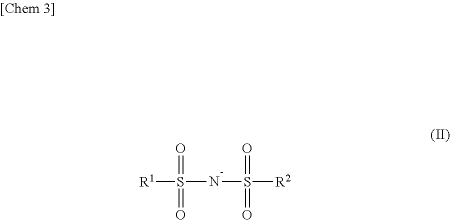

and a sodium cation.

In formula (II), R¹ and R² independently represent a fluorine atom or a perfluorinated group, which preferably contains 1 to 8 carbon atoms, more preferably 1 to 3 carbon atoms, and which is more preferably the trifluoromethyl group.

In some embodiments, multiple anions of formula (II) may be present, but preferably only one anion of formula (II) is present. Preferably, the anion of formula (II) is the bis(fluorosulfonyl)imide anion, also called the FSI anion; and/or the bis(trifluoromethylsulfonyl)imide anion, also called the TFSI anion. Even more preferably, it is the FSI anion, in which case the salt is NaFSI.

Throughout the following, it is understood that reference to the anion of formula (II) in the singular may be a reference to a plurality of anions of formula (II).

The composition according to the invention may comprise the salt (anion of formula (II) and sodium cation) in a content preferably greater than or equal to 99% by weight, more preferentially greater than or equal to 99.5% by weight, even more preferentially greater than or equal to 99.8% by weight or even 99.9% by weight, relative to the total weight of the composition. The salt content denotes the sum of the content of the anion of formula (II) and the content of the sodium cation.

The composition of the invention may comprise in particular one or more other anions and/or one or more other cations.

In particular, the composition according to the invention may comprise a weight content of sulfamate ions (NH₂SO₃⁻) of less than or equal to 3000 ppm; less than or equal to 2000 ppm; less than or equal to 1000 ppm; less than or equal to 500 ppm; less than or equal to 300 ppm; less than or equal to 200 ppm; less than or equal to 100 ppm; less than or equal to 50 ppm; less than or equal to 20 ppm.

The composition according to the invention may in particular comprise a sulfamate ion content of from 0.1 to 3000 ppm, preferably from 0.5 to 3000 ppm, more preferably from 1 to 1000 ppm, more preferably from 10 to 300 ppm by weight.

The composition according to the invention may in particular comprise a sulfamate ion content of from 0.1 to 10 ppm; from 10 to 50 ppm, from 50 to 100 ppm; from 100 to 200 ppm; from 200 to 300 ppm; from 300 to 500 ppm; from 500 to 1000 ppm; from 1000 to 2000 ppm; from 2000 to 3000 ppm by weight.

The sulfamate ion content indicated above can make it possible to obtain optimal performance of the composition, notably when it is used in an Na-ion battery electrolyte.

In certain embodiments, the composition optionally comprises acetamide, in a content of less than or equal to 1000 ppm, preferably less than or equal to 500 ppm, more preferably less than or equal to 100 ppm. The acetamide may be essentially absent or be present in an amount greater than or equal to 0.1 ppm by weight, or 1 ppm by weight, or 2 ppm by weight. For example, the acetamide content may be from 0 to 1000 ppm, preferably from 1 to 500 ppm, more preferably from 2 to 100 ppm by weight.

In certain embodiments, the composition optionally comprises water, in a content of less than or equal to 500 ppm, preferably less than or equal to 200 ppm, preferably less than or equal to 100 ppm, in certain cases less than or equal to 50 ppm by weight. The water may be essentially absent or be present in an amount greater than or equal to 0.1 ppm by weight, or 0.5 ppm by weight or 1 ppm by weight. For example, the water content may be from 0 to 500 ppm, or from 0.5 to 100 ppm, or from 1 to 50 ppm, by weight.

In certain embodiments, the composition optionally comprises Cl⁻ ions in a content of less than or equal to 50 ppm, preferably less than or equal to 20 ppm, preferably less than or equal to 10 ppm by weight. The Cl⁻ ions may be essentially absent or be present in an amount greater than or equal to 0.1 ppm by weight, or 0.5 ppm by weight or 1 ppm by weight. For example, the content of Cl⁻ ions may be from 0 to 50 ppm, or from 0.5 to 20 ppm, or from 1 to 10 ppm, by weight.

In certain embodiments, the composition optionally comprises F⁻ ions in a content of less than or equal to 100 ppm, preferably less than or equal to 50 ppm, preferably less than or equal to 10 ppm by weight. The F⁻ ions may be essentially absent or be present in an amount greater than or equal to 0.1 ppm by weight, or 0.5 ppm by weight or 1 ppm by weight. For example, the content of F⁻ ions may be from 0 to 100 ppm, or from 0.5 to 50 ppm, or from 1 to 10 ppm, by weight.

In certain embodiments, the composition optionally comprises SO₄²⁻ ions, in a content of less than or equal to 3000 ppm, preferably less than or equal to 500 ppm, preferably less than or equal to 100 ppm by weight, or even less than or equal to 20 ppm by weight. The SO₄²⁻ ions may be essentially absent or be present in an amount greater than or equal to 0.1 ppm by weight, or 0.5 ppm by weight or 1 ppm by weight. For example, the content of SO₄²⁻ ions may be from 0 to 3000 ppm, or from 0.5 to 500 ppm, or from 1 to 20 ppm, by weight.

In certain embodiments, the composition optionally comprises FSO₃⁻ ions in a content of less than or equal to 100 ppm, preferably less than or equal to 50 ppm, preferably less than or equal to 10 ppm by weight. The FSO₃⁻ ions may be essentially absent or be present in an amount greater than or equal to 0.1 ppm by weight, or 0.5 ppm by weight or 1 ppm by weight. For example, the content of FSO₃⁻ ions may be from 0 to 100 ppm, or from 0.5 to 50 ppm, or from 1 to 10 ppm, by weight.

The content of ions in the composition may be analysed by ion chromatography and/or by inductively coupled plasma mass spectrometry (ICP-MS) or inductively coupled plasma atomic emission spectrometry (ICP-AES) and/or by X-ray fluorescence spectrometry (XRF).

The water content can be determined by Karl Fischer analysis.

The content of acetamide and of FSO₃⁻ ions can be determined by nuclear magnetic resonance (¹⁹F and ¹H).

### General Scheme for Preparing the Composition

The composition may be prepared by a process comprising the following steps:
optionally, synthesizing the compound of formula (I):

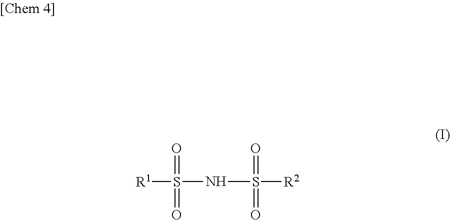

reacting the compound of formula (I) with a sodium compound;
optionally, purifying the reaction mixture.

In formula (I), R¹ and R² have the same meaning as in formula (II).

In particular, when R¹=R²=F, the compound of formula (I) is bis(fluorosulfonyl)imide or HFSI (which makes it possible to obtain NaFSI).

In particular, when R¹=R²=CF₃, the compound of formula (I) is bis(trifluoromethylsulfonyl)imide (which makes it possible to obtain NaTFSI).

### Synthesis of the Compound of Formula (I)

The compound of formula (I) can be synthesized in particular by fluorination of a chlorinated compound. The chlorinated compound has the same structure as the compound of formula (I), except that R¹ and R² independently represent a halogen atom (F or Cl) or a perhalogenated group, which preferably contains from 1 to 8 carbon atoms, more preferably from 1 to 3 carbon atoms, and which is more preferably the trihalomethyl group, provided that the chlorinated compound comprises at least one chlorine atom. Preferably, the chlorinated compound is of formula (I), R¹ and R² independently representing a chlorine atom or a perchlorinated group, which preferably contains from 1 to 8 carbon atoms, more preferably from 1 to 3 carbon atoms, and which is more preferably the trichloromethyl group.

In particular, the chlorinated compound may be (bis(chlorosulfonyl)imide), which makes it possible to obtain HFSI.

In particular, the chlorinated compound may be (bis(trichloromethylsulfonyl)imide), which makes it possible to obtain bis(trifluoromethylsulfonyl)imide.

The fluorination is carried out by bringing the chlorinated compound into contact with a fluorinating agent, which is preferably chosen from the group consisting of HF (preferably anhydrous HF), KF, AsF₃, BiF₃, ZnF₂, SnF₂, PbF₂, CuF₂ and mixtures thereof, the fluorinating agent more preferably being HF, and even more preferably anhydrous HF. “Anhydrous HF” is understood to mean HF containing less than 500 ppm of water, preferably less than 300 ppm of water, preferably less than 200 ppm of water.

The fluorination is preferably carried out in at least one organic solvent SO1. The organic solvent SO1 preferably has a donor number of between 1 and 70, and advantageously of between 5 and 65. The donor number of a solvent represents the value −ΔH, ΔH being the enthalpy of the interaction between the solvent and antimony pentachloride (according to the method described in Journal of Solution Chemistry, vol. 13, no. 9, 1984). As organic solvent SO1, mention may in particular be made of esters, nitriles, dinitriles, ethers, diethers, amines, phosphines, and mixtures thereof.

The organic solvent SO1 is preferably chosen from the group consisting of methyl acetate, ethyl acetate, butyl acetate, acetonitrile, propionitrile, isobutyronitrile, glutaronitrile, dioxane, tetrahydrofuran, triethylamine, tripropylamine, diethylisopropylamine, pyridine, trimethylphosphine, triethylphosphine, diethylisopropylphosphine, and mixtures thereof. In particular, the organic solvent SO1 is dioxane.

The fluorination can be carried out at a temperature between 0° C. and the boiling point of the organic solvent SO1 (or of the mixture of organic solvents SO1). Preferably, step b) is carried out at a temperature between 5° C. and the boiling point of the organic solvent SO1 (or of the mixture of organic solvents SO1), preferentially between 20° C. and the boiling point of the organic solvent SO1 (or a mixture of organic solvents SO1).

The fluorination, preferably with anhydrous fluorohydric acid, can be carried out at a pressure of between 0 and 16 bar abs.

The fluorination is preferably carried out by dissolving the chlorinated compound in the organic solvent SO1, or the mixture of organic solvents SO1, before the reaction with the fluorinating agent (preferably anhydrous HF).

The weight ratio between the chlorinated compound and the organic solvent SO1, or the mixture of organic solvents SO1, is preferably between 0.001 and 10, and advantageously between 0.005 and 5.

According to one embodiment, anhydrous HF is introduced into the reaction medium, preferably in gaseous form.

The mole ratio between the fluorinating agent, preferably anhydrous HF, and the chlorinated compound is preferably between 1 and 10, and advantageously between 1 and 5.

The reaction with the fluorinating agent, preferably anhydrous HF, can be carried out in a closed medium or in an open medium, preferably in an open medium with in particular release of HCl in gas form.

The fluorination reaction typically leads to the formation of HCl, the majority of which can be degassed from the reaction medium (just like the excess HF if the fluorinating agent is HF), for example by stripping with an inert gas (such as nitrogen, helium or argon).

However, residual HF and/or residual HCl may be dissolved in the reaction medium. In the case of HCl, the amounts are very low since, at the working pressures and temperature, HCl is mainly in gas form.

The composition obtained on conclusion of the fluorination reaction can be stored in an HF-resistant container.

The product obtained on conclusion of the fluorination reaction may comprise HF (in particular unreacted HF), the chlorinated compound, the solvent SO1 (for instance dioxane), and optionally HCl, and/or optionally heavy compounds.

After the reaction, the compound of formula (I) can be purified, in particular by one or more distillation steps.

According to one embodiment, the distillation step makes it possible to form and recover:
a first stream F1 comprising HF, optionally the organic solvent SO1 and/or optionally HCl, preferably at the top of the distillation column, said stream F1 being gaseous or liquid;
a second stream F2 comprising the compound of formula (I), and optionally heavy compounds, preferably at the bottom of the distillation column, said stream F2 preferably being liquid.

When stream F2 comprises heavy compounds, it may be subjected to an additional distillation step in a second distillation column, to form and to recover:
a stream F2-1 comprising the compound of formula (I), free of heavy compounds, preferably at the top of the distillation column, said stream F2-1 preferably being liquid,
a stream F2-2 comprising the heavy compounds and the compound of formula (I), preferably at the bottom of the distillation column, said stream F2-2 containing less than 10% by weight of the compound of formula (I) contained in the composition obtained in step b), preferably less than 7% by weight and preferentially less than 5% by weight, said stream F2-2 preferably being liquid.

“Heavy compounds” is understood to mean organic compounds having a boiling point higher than that of the compound of formula (I). They may result from cleavage reactions of the chlorinated compound leading, for example, to compounds such as FSO₂NH₂, and/or from solvent degradation reactions, leading to the formation of oligomers.

According to one embodiment, the distillation step makes it possible to form and recover:
a first stream F′1 comprising HF, optionally the organic solvent SO1 and/or optionally HCl, preferably at the top of the distillation column, said stream F′1 being gaseous or liquid;
a second stream F′2 comprising the compound of formula (I), preferably recovered by sidestream withdrawal, said stream F′2 preferably being liquid,
a third stream F′3 comprising heavy compounds and the compound of formula (I), preferably at the bottom of the distillation column, said stream F′3 containing less than 10% by weight of the compound of formula (II) contained in the composition obtained in step b), preferably less than 7% by weight and preferentially less than 5% by weight, said stream F′3 preferably being liquid.

To carry out the sidestream withdrawal, the distillation column may contain at least one tray.

The distillation step can be carried out at a pressure ranging from 0 to 5 bar abs, preferably from 0 to 3 bar abs, preferentially from 0 to 2 bar abs, and advantageously from 0 to 1 bar abs.

The distillation step can be carried out in any conventional device. This may be a distillation device comprising a distillation column, a boiler and a condenser. The distillation column may comprise at least one packing, for instance random packing and/or structured packing, and/or trays, for instance perforated trays, fixed valve trays, moving valve trays, bubble cap trays or combinations thereof.

On conclusion of the purification, the compound of formula (I) can be recovered with a high purity. The use of a compound of formula (I) of high purity advantageously makes it possible to prepare a composition comprising a salt of high purity, avoiding complex subsequent purification steps.

The product collected (and/or used for the reaction with the sodium compound) thus preferably comprises at least 95% by weight of compound of formula (I), more preferably at least 98% by weight, at least 99% by weight, at least 99.5% by weight or even at least 99.8% by weight of compound of formula (I).

The product collected (and/or used for the reaction with the sodium compound) preferably has a sulfamic acid content of less than or equal to 5000 ppm, preferably less than or equal to 4000 ppm, less than or equal to 3000 ppm, less than or equal to 2500 ppm, or even less than or equal to 2000 ppm, by weight. In certain cases, sulfamic acid may be essentially absent, or present in a content of at least 1 ppm by weight. The sulfamic acid content may be in particular from 1 to 5000 ppm, from 10 to 4000 ppm, from 100 to 3000 ppm or from 500 to 2500 ppm by weight. It may be, for example, from 1 to 10 ppm, from 10 to 50 ppm, from 50 to 100 ppm, from 100 to 200 ppm, from 200 to 500 ppm, from 500 to 1000 ppm, from 1000 to 2000 ppm, from 2000 to 3000 ppm, from 3000 to 4000 ppm or from 4000 to 5000 ppm by weight. The sulfamic acid content can be determined by ion chromatography (expressed as NH₂SO₃⁻).

For ion chromatography measurements, it is possible in particular to use the THERMO ICS-5000 device. It has two analytical channels, one of which is dedicated to anion analysis and consists of:
a supply of ultra pure water (18.2 Mohm) via a dual-piston pump;
an automatic eluent generator (EGC);
a valve with injection loop (volume=25 microliters);
a guard column (AG19, T=35° C.) and a separator column (AS19, T=20° C.);
a suppressor (AERS 62 mA);
a conductivity meter for for detecting the peaks.

The eluent used may be a KOH solution at a concentration of 25 mmol/L and may have a flow rate of 1 mL/min.

Reaction of the Compound of Formula (I) with the Sodium Compound

The term “sodium compound” is understood to mean a compound comprising sodium.

The reaction with the sodium compound can be an ion-exchange reaction. In this case, the soda compound may in particular be NaCl.

Alternatively, the reaction may be an acid-base reaction, in which case the sodium compound is a sodium base.

The term “sodium base” is understood to mean a basic compound comprising sodium.

The sodium base may in particular be chosen from NaH, NaOH, NaHCO₃, Na₂CO₃, Na(OAc) (sodium acetate) and mixtures thereof. Preferably, Na₂CO₃ is used.

The reaction can be carried out in the presence of an organic solvent, which makes it possible in particular to facilitate the recovery of the compound of formula (II). A solvent in which the compound of formula (II) is soluble is preferably chosen. The organic solvent may be chosen in particular from nitriles (in particular acetonitrile, propionitrile or butyronitrile), esters (in particular methyl, ethyl, propyl, isopropyl or butyl acetate), ethers (in particular diethyl ether or methyl tert-butyl ether), ketones (in particular acetone or methyl ethyl ketone), alcohols (in particular methanol, ethanol or isopropanol), carbonates (in particular dimethyl carbonate, diethyl carbonate or ethyl methyl carbonate) and mixtures thereof.

Preferably, the reaction is carried out in the presence of acetonitrile as organic solvent.

The reaction can be carried out by pouring the compound of formula (I) onto a dispersion of the sodium compound (for example the sodium base) in the organic solvent. The weight ratio of the solvent to the compound of formula (I) may be between 0.5 and 10, preferably between 1 and 4. The mole ratio between the sodium compound (Na equivalent) and the compound of formula (I) may be between 0.9 and 1.1, preferably between 1 and 1.05. The reaction temperature can be from −5° C. to 40° C., preferably from 15° C. to 25° C.

At the end of the reaction, the reaction mixture can be purified. The purification may comprise filtration, crystallization, and one or more washes; or preferably filtration followed by crystallization and optionally one or more washes.

The crystallization may be carried out by evaporating the solvent, in particular under vacuum or at atmospheric pressure, for example by batch evaporation, by continuous evaporation with a falling-film evaporator, or a thin-film evaporator, or alternatively a short-path wiped-film evaporator.

Preferably, crystallization is carried out by adding an organic solvent which is a non-solvent with respect to the compound of formula (II). The compound of formula (II) may be present in a solids content of greater than or equal to 50%, preferably greater than or equal to 70%. The organic solvent may be chosen in particular from chlorinated solvents such as dichloromethane or dichloroethane, aromatic solvents such as toluene or xylenes, or alkanes (linear, branched or cyclic) such as pentane, cyclohexane or heptane, and also from mixtures thereof. The crystallization can be carried out in particular at a temperature between −15° C. and 25° C.

Optionally, the product may be washed one or more times, in particular with the organic solvent as described above with regard to the crystallization. Preferably, the organic solvent used for the wash(es) is the same as the one used for the crystallization.

Finally, the product can be dried, for example in a vacuum oven.

The yield of compound of formula (II) obtained may be greater than 70 mol %, or greater than 80 mol %, or greater than 90 mol %, or even greater than 95 mol %, relative to the reactant of formula (I).

The product obtained can be characterized by nuclear magnetic resonance, by Karl Fischer analysis for its water content and by ion chromatography for its anion and cation content.

### Electrolyte

The composition described above can be included in an electrolyte. The electrolyte may comprise the salt described above in a weight proportion which may be from 1% to 70%, preferably from 3% to 50%, more preferably from 5% to 30%.

The electrolyte is preferably non-aqueous. It is therefore free of water or essentially free of water. The water content may be from 0 to 500 ppm, preferably from 0.5 to 100 ppm and more preferably from 1 to 50 ppm by weight.

The content of sulfamate ions in the electrolyte may be from 0.1 to 3000 ppm, preferably from 1 to 1000 ppm and more preferably from 10 to 300 ppm, by weight.

The content of acetamide in the electrolyte may be from 0 to 1000 ppm, preferably from 1 to 500 ppm, more preferably from 2 to 100 ppm by weight.

The content of Cl⁻ ions in the electrolyte may be from 0 to 50 ppm, preferably from 0.5 to 20 ppm, more preferably from 1 to 10 ppm.

The content of F⁻ ions in the electrolyte may be from 0 to 100 ppm, preferably from 0.5 to 50 ppm, more preferably from 1 to 10 ppm.

The content of SO₄²⁻ ions in the electrolyte may be from 0 to 3000 ppm, preferably from 0.5 to 500 ppm, more preferably from 1 to 20 ppm.

The content of FSO₃⁻ ions in the electrolyte may be from 0 to 100 ppm, preferably from 0.5 to 50 ppm, more preferably from 1 to 10 ppm.

The electrolyte may comprise, in addition to the composition according to the invention, one or more other sodium salts, one or more solvents and one or more additives.

The other sodium salts may be chosen in particular from NaPF₆, NaClO₄, NaBF₄, NaOTf (sodium triflate), NaBOB (sodium bis(oxalato)borate), NaDFOB (sodium difluoro(oxalato)borate), NaTDI (sodium 4,5-dicyano-2-trifluoromethylimidazolide) and combinations thereof. When several sodium salts are used in combination, the total content of all the sodium salts is preferably from 1% to 70%, more preferably from 3% to 50%, more preferably from 5% to 30% by weight. In certain embodiments, the electrolyte consists essentially, or even consists, of the composition described above (optionally in combination with one or more other sodium salts), the solvent(s) and the additive(s).

The solvent(s) may be chosen in particular from: ethers, in particular dimethoxyethane (DME), diethylene glycol dimethyl ether (DEGDME) or tetraethylene glycol dimethyl ether (TEGDME); esters, in particular ethyl acetate or methyl propionate; lactones, in particular gamma-butyrolactone; nitriles, in particular acetonitrile; sulfoxides, in particular dimethyl sulfoxide; sulfones, in particular sulfolane; carbonates; and combinations thereof.

Among the carbonates, the solvent(s) may notably be C3-C6 alkyl carbonate solvents, in particular which are cyclic and/or linear.

In certain embodiments, a mixture of at least two solvents is provided, namely a cyclic C3-C6 alkyl carbonate solvent and a linear C3-C6 alkyl carbonate solvent.

As cyclic C3-C6 alkyl carbonate, use may notably be made of ethylene carbonate (EC), butylene carbonate (BC) or propylene carbonate (PC).

As linear C3-C6 alkylcarbonate, use may notably be made of dimethyl carbonate (DMC), diethyl carbonate (DEC) or ethyl methyl carbonate (EMC).

The additives may comprise a C2-C6 alkylene carbonate.

The additives may comprise a C1-C8 nitrile.

The additives may comprise a C2-C6 alkylene carbonate and a C1-C8 nitrile.

The C2-C6 alkylene carbonate may be cyclic or linear. For example, the C2-C6 alkylene carbonate may be a vinylene carbonate.

The C1-C8 nitrile may comprise at least two nitrile units. Preferably, the C1-C8 nitrile may have the general formula NC—(CH)ₙ—CN with n being an integer from 1 to 6, preferably 2, 3 or 4. The C1-C8 nitrile may be chosen from adiponitrile, succinonitrile or glutaronitrile, adiponitrile being preferred (n=4).

The electrolyte may in particular comprise from 2% to 10% by weight of C2-C6 alkylene carbonate(s).

The electrolyte may in particular comprise from 0.2% to 5% by weight of C1-C8 nitrile(s).

As additives, the electrolyte may also comprise at least one fluorinated carbonate, such as FEC (fluoroethylene carbonate) or F2EC (difluoroethylene carbonate); or at least one phosphate such as TMP (trimethylphosphate) or phosphite such as TMSPI (tris(trimethylsilyl)phosphite).

The electrolyte may also include an ionic liquid (in addition to the solvents and additives described above). Ionic liquids are salts which possess a melting point below 100° C. and preferably below room temperature (i.e. below a temperature ranging from 15° C. to 35° C.). Thus, an “ionic liquid” is understood to mean a salt, that is to say an ionic compound comprising at least one anion and one cation, present in liquid form at a temperature of 100° C. The ionic liquids that may be present are in particular those which comprise FSI or TFSI as anion, in combination with an onium cation, preferably chosen from the group consisting of quaternary ammonium ions, pyridinium ions, imidazolium ions, oxazolidinium ions, piperidinium ions, phosphonium ions, pyrrolidinium ions, sulfonium ions, oxonium ions, and mixtures thereof. The onium cation may in particular be trimethylpropylammonium, trimethylbutylammonium, trimethylhexylammonium, tributylmethylammonium, 1-ethyl-3-methylimidazolium, 1-butyl-3-methylimidazolium, 1-butyl-1-methylpyrrolidinium, 1-propyl-3-methylpyrrolidinium, 1-butyl-1-methylpiperidinium, 1-methyl-1-propylpiperidinium and methyl(triethyl)phosphonium.

### Electrochemical Cell and Battery

The invention also relates to an electrochemical cell comprising an electrolyte as described above. The electrochemical cell also comprises a negative electrode (or anode) and a positive electrode (or cathode).

The electrochemical cell can also comprise a separator, in which the electrolyte is impregnated. The electrolyte wets the electrodes and the separator.

A “negative electrode” means the electrode which acts as anode when the cell delivers current (that is to say, when it is in the process of discharging) and which acts as cathode when the cell is in the process of charging.

The negative electrode typically comprises an electrochemically active material (negative material), optionally an electronically conductive material, and optionally a binder; preferably a negative material, an electronically conductive material and a binder.

A “positive electrode” means the electrode which acts as cathode when the cell delivers current (that is to say, when it is in the process of discharging) and which acts as anode when the cell is in the process of charging.

The positive electrode typically comprises an electrochemically active material (positive material), optionally an electronically conductive material, and optionally a binder; preferably a negative material, an electronically conductive material and a binder.

The term “electrochemically active material” is understood to mean a material capable of reversibly inserting ions.

The term “electronically conductive material” is understood to mean a material that is capable of conducting electrons.

In each electrode independently, the electronically conductive material is preferably conductive carbon.

The conductive carbon ensures electronic conductivity and can be essentially any carbon exhibiting electronic conductivity behavior such as in particular carbon nanoparticles, carbon black, graphite, Ketjen® carbon, Shawinigan carbon, graphene, carbon nanotubes, carbon fibers (for example vapor-grown carbon fibers or VGCF), non-powdery carbon obtained by carbonization of an organic precursor, or a combination of two or more of these.

In each electrode independently, the binder may be any polymer that ensures the mechanical integrity of the electrode.

The material of each electrode may also comprise a binder. Nonlimiting examples of binders include linear, branched and/or crosslinked polyether polymer binders (for example polymers based on poly(ethylene oxide) (PEO), or poly(propylene oxide) (PPO) or on a mixture of the two (or an EO/PO copolymer), and optionally comprising crosslinkable units), water-soluble binders (such as polyacrylic acid, CMC (carboxymethylcellulose), SBR (styrene/butadiene rubber), NBR (acrylonitrile/butadiene rubber), HNBR (hydrogenated NBR), CHR (epichlorohydrin rubber), ACM (acrylate rubber)), or fluoropolymer binders (such as PVDF (polyvinylidene fluoride), PTFE (polytetrafluoroethylene)), and combinations thereof.

Preferably, it may be polyacrylic acid, CMC (for example in combination with SBR), or PVDF.

The negative material can be any carbon that has amorphous and graphitic domains with different ratios. It includes hard and soft carbons. Hard carbon is a solid form of carbon which cannot be converted to graphite by heat treatment, unlike soft carbon. Consequently, the amorphous domain of soft carbons is reorganized into graphitic planes during an appropriate heat treatment. Soft carbon therefore represents graphitizable non-graphite carbon with high electronic conductivity, the degrees of graphitization and the interlayer distance of which can be adjusted by heat treatment.

Soft carbon may, for example, comprise soft carbon derived from pitch, carbon black, spherical carbon derived from mesitylene or partially carbonized aromatic hydrocarbons doped with heteroatoms.

The negative material can be any mixture of hard and soft carbons and can be post-treated either with a heat treatment or with a chemical treatment using acidic or alkaline media.

The positive material may be a polyanionic compound, preferably comprising sodium. This includes in particular lamellar oxides. In certain embodiments, the polyanionic compound may be of formula NaMₓO_{y} with x preferably being from 1 to 2 and y preferably being from 2 to 3, for example NaMO₂. In these two formulae, and also all those below, M represents a metal or a mixture of metals.

Optionally, the oxygen can be substituted partially or completely, preferably partially, by any other element, for example a halogen and preferably fluorine: for example, the corresponding materials may have the formula NaMₓO_{y-z}F_{z}, with z being from 0 to y, and x and y preferably being in the above ranges.

Optionally, the oxygen may be substituted partially or completely, preferably completely, by a sulfate, phosphate or silicate and optionally by another element, in particular a halogen, preferably fluorine.

It may in particular be a compound of formula Na_{q}Mₓ(PO₄)_{y}F_{z} preferably with q=1 to 4, x=2 to 4, y=2 to 4 and z=0 to 3, for example Na₃V₂(PO₄)₂F₃.

It may also be a compound of formula Na_{q}Mₓ(SO₄)_{y} preferably with q=1 to 4, x=1 to 4, y=1 to 4, for example Na₂Fe(SO₄)₂. It can also be a compound Na_{q}Mₓ(SiO₄)_{y} preferably with q=1 to 4, x=1 to 2 and y=1 to 4, such as Na₂FeSiO₄ for example.

The negative electrode can be supported, for example, on aluminum foil.

The positive electrode can be supported, for example, on aluminum foil.

In both cases, the aluminum foil can have a thickness of approximately 5 to 40 μm.

The aluminum may have been treated chemically or with a specific coating such as a carbon coating.

The support (for example aluminum foil) can be coated with an ink or dispersion comprising the active material (positive or negative), the electronically conductive material (for example conductive carbon), the binder and a solvent.

The solvent can be water or an aqueous solution, or an organic solvent (for example ethanol, N-methylpyrrolidone, etc.) which guarantees the homogeneous mixing of the constituents and the possibility of coating the ink by a coating method, for example with a slot die or a Comma Coater® device. The viscosity of the solution can be adjusted by the dry mass ratio, defined as the mass of all solids to the total mass (solids and liquids). When the binder is carboxymethylcellulose or polyacrylic acid, water or an aqueous solution is preferably used. When the binder is polyvinylidene fluoride, an organic solvent is preferably used.

The separator may be a porous membrane, which acts as a barrier between the negative and positive electrodes and is electronically insulating but ionically conductive.

The separator may comprise or be based on a polyolefin or cellulose. As polyolefin, use may be made of an ethylene homopolymer, a propylene homopolymer, an ethylene/butene copolymer, an ethylene/hexene copolymer, an ethylene/methacrylate copolymer, or a multilayer structure of the above polymers. Alternatively, the separator may be made of glass fibers.

The invention also relates to a battery comprising at least one, and preferably two or more, electrochemical cells as described above. The electrochemical cells can be assembled in series and/or in parallel in the battery.

### EXAMPLES

The following examples illustrate the invention without limiting it.

### Example 1

175.7 g of sodium carbonate (1.66 mol) and 2100 g of acetonitrile are charged to a 4-liter reactor. With stirring and while maintaining the temperature between 15° C. and 20° C., 600 g of molten HFSI (3.31 mol) are poured in over a period of 2 hours. At the end of the addition, the mixture is left to react for 4 hours at 20° C. The pH of the solution is then 6. The solution is filtered, and then evaporated under vacuum at 40° C. on a rotary evaporator. The drying is completed in a vacuum oven. 652 g of NaFSI are obtained in the form of a white powder. The yield is 97%.

¹⁹F NMR analysis shows the presence of a peak corresponding to NaFSI.

¹H NMR analysis shows the presence of acetamide at a content of 300 ppm.

Karl Fischer analysis shows that the water content is 10 ppm.

The analysis by ion chromatography is as follows:

$${NH}_{2} {SO}_{{3}^{-}} = 540 ppm \\ {Cl}^{-} < 5 ppm \\ {F}^{-} = 80 ppm \\ {SO}_{4}^{2 -} = 1680 ppm \\ {FSO}_{{3}^{-}} < 5 ppm$$

### Example 2

215.4 g of sodium carbonate (2.03 mol) and 5600 g of acetonitrile are charged to a 10-liter reactor. With stirring and while maintaining the temperature between 15° C. and 20° C., 700 g of molten HFSI (3.87 mol) are poured in over a period of 2 hours. At the end of the addition, the mixture is left to react for 2 hours at 20° C. The solution is filtered, and then concentrated under vacuum with a short-path thin-film evaporator to a concentration of 75%. The concentrated solution thus obtained is poured into 2250 g of dichloromethane and is left overnight at 5° C. The solution is then filtered, and the precipitate is washed with dichloromethane and then dried on a filter under nitrogen at 40° C. 715 g of NaFSI are obtained in the form of a white powder. The yield is 91%.

¹⁹F NMR analysis shows the presence of a peak corresponding to NaFSI.

¹H NMR analysis shows the presence of acetamide at a content of 40 ppm.

Karl Fischer analysis shows that the water content is 50 ppm.

The analysis by ion chromatography is as follows:

$${NH}_{2} {SO}_{{3}^{-}} = 20 ppm \\ {Cl}^{-} < 5 ppm \\ {F}^{-} < 5 ppm \\ {SO}_{4}^{2 -} < 5 ppm \\ {FSO}_{{3}^{-}} < 5 ppm$$

1. A composition comprising a salt composed of a sodium cation and an anion of formula (II): 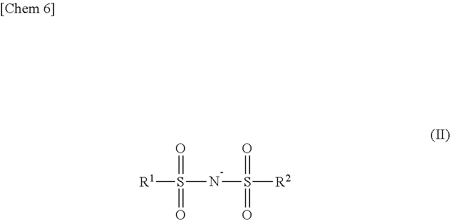
wherein R¹ and R² independently represent a fluorine atom or a perfluorinated group, the composition having a sulfamate ion content of from 0.1 to 3000 ppm by weight.

2. The composition as claimed in claim 1, wherein the anion of formula (II) is the bis(fluorosulfonyl)imide anion or the bis(trifluoromethylsulfonyl)imide anion, preferably the bis(fluorosulfonyl)imide anion.

3. The composition as claimed in claim 1, wherein the sulfamate ion content is from 1 to 1000 ppm, preferably from 10 to 300 ppm, by weight.

4. The composition as claimed in claim 1, wherein the salt is present in a weight content of greater than or equal to 99.5% by weight, preferably greater than or equal to 99.8% by weight, more preferably greater than or equal to 99.9% by weight.

5. The composition as claimed in claim 1, also comprising, by weight:
from 0 to 500 ppm of water, preferably from 0.5 to 100 ppm and more preferably from 1 to 50 ppm;
from 0 to 50 ppm of Cl⁻ ions, preferably from 0.5 to 20 ppm, more preferably from 1 to 10 ppm;
from 0 to 100 ppm of F⁻ ions, preferably from 0.5 to 50 ppm, more preferably from 1 to 10 ppm;
from 0 to 3000 ppm of SO₄²⁻ ions, preferably from 0.5 to 500 ppm, more preferably from 1 to 20 ppm;
from 0 to 100 ppm of FSO₃⁻ ions, preferably from 0.5 to 50 ppm, more preferably from 1 to 10 ppm.

6. A process for preparing the composition of claim 1 comprising:
supplying the compound of formula (I): 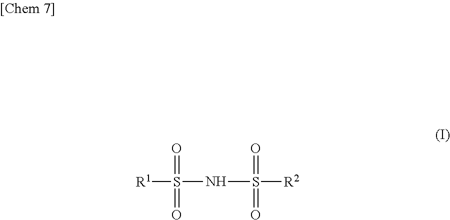
wherein R¹ and R² independently represent a fluorine atom or a perfluorinated group,
reacting the compound of formula (I) with a sodium compound.

7. The process as claimed in claim 6, wherein the compound of formula (I) has a sulfamic acid content of from 1 to 5000 ppm, preferably from 500 to 2500 ppm, by weight.

8. The process as claimed in claim 6, wherein the sodium compound is NaCl, or a sodium base, which is preferably chosen from NaH, NaOH, NaHCO₃, Na₂CO₃ and Na(OAc), and is preferably Na₂CO₃.

9. The process as claimed in claim 6, wherein the reaction is carried out:
in the presence of an organic solvent, preferably chosen from nitriles, esters, ethers, ketones, alcohols, carbonates and combinations thereof; and/or
with a sodium compound/compound of formula (I) mole ratio of from 0.9 to 1.1, preferably from 1 to 1.05; and/or
at a temperature of from −5° C. to 40° C., preferably from 15° C. to 25° C.

10. The process as claimed in claim 6, comprising the following step:
synthesizing the compound of formula (I), preferably by fluorination of a chlorinated compound and optionally distillation.

11. The process as claimed in claim 6, further comprising the following step:
purifying the reaction mixture after the reaction, preferably by filtration and crystallization.

12. The process as claimed in claim 11, wherein the crystallization is carried out in the presence of a non-solvent for the compound of formula (II), preferably chosen from chlorinated solvents, aromatic solvents, alkanes and combinations thereof.

13. An electrolyte comprising the composition as claimed in claim 1, mixed with one or more solvents and optionally one or more additives.

14. The electrolyte as claimed in claim 13, further comprising an ionic liquid, which preferably comprises the FSI or TFSI anion associated with an onium cation.

15. An electrochemical cell comprising a negative electrode, a positive electrode and an electrolyte, wherein the electrolyte comprises the composition as claimed in claim 1.

16. The cell as claimed in claim 15, wherein the negative electrode comprises hard and/or soft carbon as the electrochemically active material, and wherein the positive electrode comprises a polyanionic compound comprising sodium.

17. A battery comprising at least one electrochemical cell as claimed in claim 15.
